(19) United States
(12) Patent Application Publication
(10) Pub. No.: US 2005/0207472 A1
(43) Pub. Date: Sep. 22, 2005

(54) Medium detecting device, medium detecting method, recording-medium playback apparatus, and computer product

(75) Inventors: Hiroyuki Matsumoto, Saitama (JP); Takeshi Matsumoto, Saitama (JP); Katsunori Tamamura, Saitama (JP); Takao Yoshida, Saitama (JP); Fumito Inaba, Saitama (JP); Takashi Mizoguchi, Saitama (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/080,903

(22) Filed: Mar. 16, 2005

(30) Foreign Application Priority Data
Mar. 17, 2004 (JP) 2004-075879

(51) Int. Cl. G01K 11/00

(52) U.S. Cl. 374/161

(57) ABSTRACT

An output of an optical sensor in the initial state, that is, when a disc is absent, is set as a reference value. A threshold for detecting the disc is calculated by adding a predetermined variation to the reference value. When the output of the optical sensor exceeds the threshold, it is determined that the disc is present.

### BACKGROUND OF THE INVENTION

1) Field of the Invention

The present invention relates to a technology for detecting a recording medium using an optical sensor.

2) Description of the Related Art

An optical sensor that detects presence or absence of an object without contacting the object is used in various scenes. For example, the optical sensor is used in an automatic teller machine (ATM) for detecting a bill, in a vending machine for detecting a coin, and in an automatic ticket gate system for detecting a ticket or a commutation ticket. The optical sensor is often used also in a recording-medium playback apparatus for detecting insertion of a recording medium (hereinafter, “disc”) such as a compact disc (CD) and a digital versatile disc (DVD).

For example, in a conventional technology disclosed in Japanese Patent Application Laid-Open No. 2003-338112, an information-recording-medium carrying device discriminates between a disc of which an outer dimension is 12 centimeter (cm) and a CD of which an outer dimension is 8 cm using an optical sensor and a micro switch. The disc of which the outer dimension is 12 cm includes a CD and a DVD of which an outer dimension is 12 cm, and a dummy disc that is formed with a CD of which an outer dimension is 8 cm attached to an adaptor of which an outer dimension is 12 cm.

Specifically, during insertion of an object being carried by a carrying roller, an insertion detecting sensor, which is the optical sensor, first detects a disc. When a detection signal of the insertion detecting sensor does not change during a predetermined masking time since the disc is detected, while a detection signal of two units of outer-dimension detecting sensor, which are the micro switches, changes, the disc is determined to be the disc of which the outer dimension is 12 cm.

In the above conventional technology, a system controller that includes a microprocessor controls the information-recording-medium carrying device and an information-record playback apparatus that includes the information-recording-medium carrying device. A collector voltage of a phototransistor that is controlled to be on/off by a light from a light emitting diode (LED) is converted into a digital signal (hereinafter, “output V1 of an optical sensor”). The output V1 of the optical sensor is a detecting signal and is distinguished between “H” and “L” depending on a value. In other words, the output V1 is divided into two values based on a predetermined threshold. When the output V1 is higher the threshold, the detecting signal is “H”, and when the output V1 is lower than the threshold, the detecting signal is “L”.

Variations in a power source, parts, temperature, and time change characteristics of the LED and the phototransistor, which constitute the optical sensor. In addition, dirt on parts affects performance of the optical sensor because the phototransistor is controlled to be on/off with the light from the LED. Therefore, the threshold should be set considering various cases in which parts of the optical sensor act at a typical value, a minimum value, and a maximum value.

FIGS. 1 to 3 are graphs of the output V1 when a photocurrent of the phototransistor has a typical value (typ), the minimum value (min), and the maximum value (max) respectively. The output V1 shown in FIGS. 1 to 3 is of an open/close type apparatus in which the LED and the phototransistor are arranged on the same board, and a light guiding board that reflects the light from the LED is arranged at a shutter. The light guiding board is structured in such a manner that the light is received when the shutter, which is arranged at an opening from which the disc is inserted, is open, and the light is not received when the shutter is closed. In other words, when the shutter is open, the phototransistor is turned on by the light reflected by the light guiding board, and when the light is blocked by the disc inserted between the light guiding board and the board, on which the LED and the phototransistor are arranged, the phototransistor is turned off. Thus, the disc is detected. A threshold SH for dividing the output V1 into the two values is, for example, 50% of a power voltage VDD of a power source VD.

FIG. 1 is the graph of the output V1 when the photocurrent of the phototransistor has the typical value. When the photocurrent has the typical value, the light from the LED does not fall on the phototransistor while the shutter is close. Therefore, the phototransistor is off, and the photocurrent does not flow. A value of the output V1 is same as a value of the power voltage VDD. When a shutter opening action is started in accordance with a loading request for inserting the disc, reflected light of the light from the LED falls on the phototransistor to turn on the phototransistor. Thus, the output V1 starts decreasing, and when the shutter opens completely, the output V1 attains a value GND, which is 0 volt (V). When the disc is inserted, the disc blocks the reflected light to turn off the phototransistor. Thus, the photocurrent stops flowing, and the output V1 increases and attains the value VDD.

In this manner, when the photocurrent of the phototransistor has the typical value, the output V1 drops below the threshold SH when the shutter opens, and rises to VDD, which is higher than the threshold, when insertion of the disc is completed. Therefore, the detection signal changes from “L” to “H” when the disc is inserted. The information-recording-medium carrying device detects insertion of the disc by monitoring the detection signal.

FIG. 2 is the graph of the output V1 when the photocurrent of the phototransistor has the minimum value. When the photocurrent has the minimum value, the light from the LED does not fall on the phototransistor while the shutter is close. Therefore, the phototransistor is off, and the photocurrent does not flow. The output V1 is equal to VDD. When the shutter opening action is started in accordance with the loading request for inserting the disc, the reflected light of the light from the LED falls on the phototransistor to turn on the phototransistor. Therefore, the output V1 decreases. When insertion of the disc is completed, the disc blocks the reflected light to turn off the phototransistor. Thus, the photocurrent is stopped, and the output V1 rises and becomes equal to VDD.

However, even when the shutter is completely open, the output V1 does not decrease to a value of the threshold SH because the photocurrent of the phototransistor is too low. Because the output V1 is higher than the threshold SH, the detection signal remains “H”. Therefore, the information-recording-medium carrying device misjudges that the disc is inserted although the disc is not actually inserted, causing a malfunction.

FIG. 3 is a graph of the output V1 when the photocurrent of the phototransistor has the maximum value. When the photocurrent has the maximum value, the light of the LED does not fall on the phototransistor while the shutter is close. Therefore, the phototransistor is off, and the photocurrent does not flow. The value of the output V1 is same as the value of the power voltage VDD. When the shutter opening action is started in accordance with the loading request for inserting the disc, the reflected light of the light from the LED falls on the phototransistor to turn on the phototransistor. Thus, the output V1 decreases. When insertion of the disc is completed, the disc blocks the reflected light to turn off the phototransistor. Thus, the photocurrent is stopped, and the output V1 increases.

However, even when insertion of the disc is completed, the output V1 is lower than the threshold SH because the photocurrent of the phototransistor is too high. The guiding board is arranged at a position at which the light from the LED is received. If the disc has high translucency (not 100% interceptable), although the disc blocks the light from the LED, the light falls on the phototransistor to some extent.

In this manner, when the photocurrent of the phototransistor has the maximum value, the output V1 does not become higher than the threshold SH even when insertion of the disc is completed. Therefore, the detection signal remains “L”. As a result, the information-recording-medium carrying device cannot detect the disc.

As described above, it is difficult to set the threshold used for detecting the disc because the characteristics of the LED and the phototransistor that are affected by various factors, such as the variations in the power source, parts, and temperature, time, and dirt on parts, or the translucency of the disc.

In the conventional technology, by sorting parts, such as a resistor, that relate to actions of the LED and the phototransistor, the variations in the parts are minimized so that the disc can be detected when the photocurrent has any of the typical value, the minimum value, and the maximum value.

However, sorting of the parts increases the manufacturing cost.

Recently, a disc that has high translucency called “C-THRU disc” is developed. Even if sorted parts are used, it is difficult to set the threshold that satisfies a condition in which any type of disc is detected when the photocurrent has any of the typical value, the minimum value, and the maximum value. Because the C-THRU disc has high translucency, the C-THRU disc allows the reflected light from the light guiding board pass through, the output V1 is kept low even when the disc is inserted.

### SUMMARY OF THE INVENTION

It is an object of the present invention to solve at least the above problems in the conventional technology.

According to an aspect of the present invention, a medium detecting device detects a medium using an optical sensor. The medium detecting device includes a determining unit that sets a reference value and determines whether the medium is present or absent from a difference between the reference value and an output value of the optical sensor. The reference value is an output value output by the optical sensor when the medium is absent.

According to another aspect of the present invention, a recording-medium playback apparatus that loads and playbacks a recording medium when the recording medium is present. The recording-medium playback apparatus includes the above medium detecting device to detect the recording medium.

According to still another aspect of the present invention, a medium detecting method detects a medium using an optical sensor and includes measuring a first output value of the optical sensor, the first output value obtained when the medium is absent; setting the first output value as a reference value; measuring a second output value of the optical sensor; and detecting the medium from a difference between the reference value and the second output value.

According to still another aspect of the present invention, a computer-readable recording medium stores therein a computer program that implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIGS. 1 to 3 are graphs of an output of a conventional optical sensor;

FIG. 4 is a block diagram of a recording-medium playback apparatus that includes a medium detecting device according to an embodiment of the present invention;

FIG. 5 is a detailed block diagram of the medium detecting device shown in FIG. 4;

FIG. 6 is a schematic for explaining the principle of an optical sensor shown in FIG. 5;

FIG. 7 is a flowchart of a process procedure performed by the medium detecting device shown in FIG. 5;

FIGS. 8 to 10 are graphs of an output of the optical sensor shown in FIG. 5.

### DETAILED DESCRIPTION

Exemplary embodiments according to the present invention will be explained in detail with reference to the accompanying drawings. The present invention is not limited to the embodiments.

A medium detecting device according to the embodiments of the present invention can detect a medium even when the photocurrent of the phototransistor varies due to various factors.

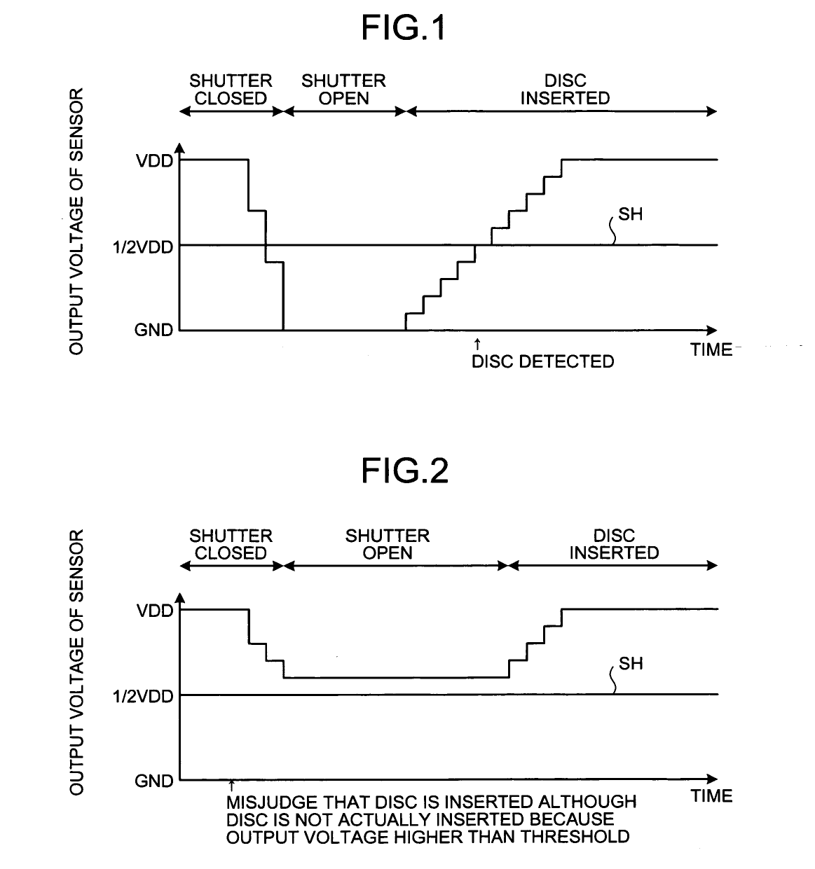

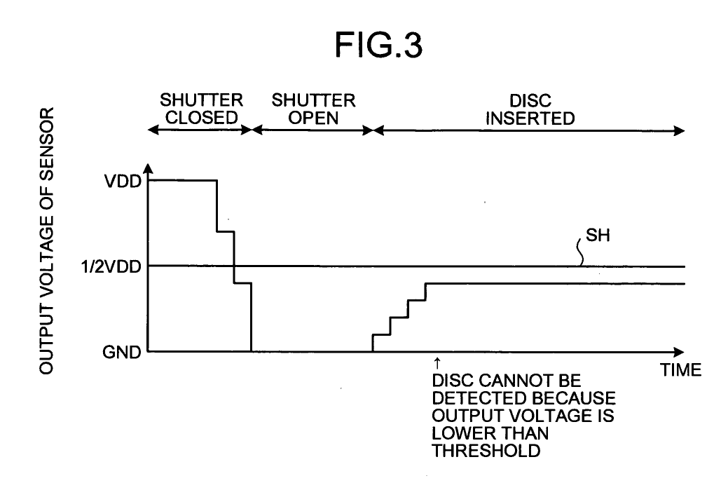

When the medium is absent (shutter open state shown in FIGS. 1 to 3), the output of the optical sensor has the minimum value, on the other hand, unless translucency of the disc is 100%, the output of the optical sensor becomes higher than the minimum value when the medium is present. Focusing on this fact, in the medium detecting device according to the embodiments, the minimum value is set as a reference value, and the medium is detected based on the difference between the reference value and the output of the optical sensor. In other words, the medium is not detected based on a fixed threshold as in the conventional technology.

Precisely, in the present invention, the threshold is not fixed, but is variable. An output of the optical sensor when the medium is absent is measured as a reference value, and a variation for determining the threshold is set in advance. The threshold is determined based on the reference value and the variation. The medium detecting device detects presence or absence of the medium based on whether a value of the output of the optical sensor exceeds the threshold thus determined. Therefore, it is possible to accurately detect the medium without using the sorted parts.

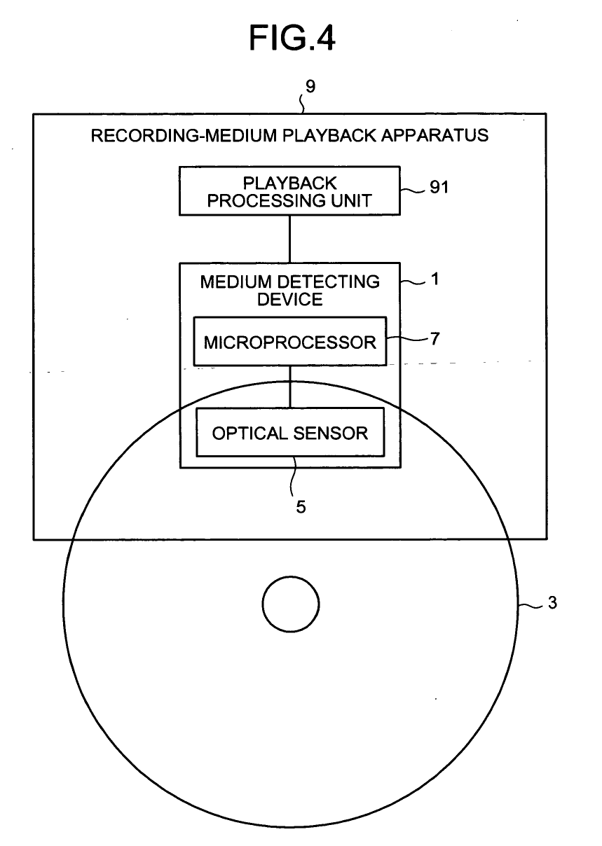

FIG. 4 is a block diagram of a recording-medium playback apparatus 9 that includes a medium detecting device 1 according to an embodiment of the present invention. The recording-medium playback apparatus 9 includes the medium detecting device 1 and a playback processing unit 91. The medium detecting device 1 determines whether a disc 3, which is a recording medium such as the CD and the DVD, is inserted. When the medium detecting device 1 determines that the disc 3 is inserted, the playback processing unit 91 loads the disc 3 and performs a playback processing.

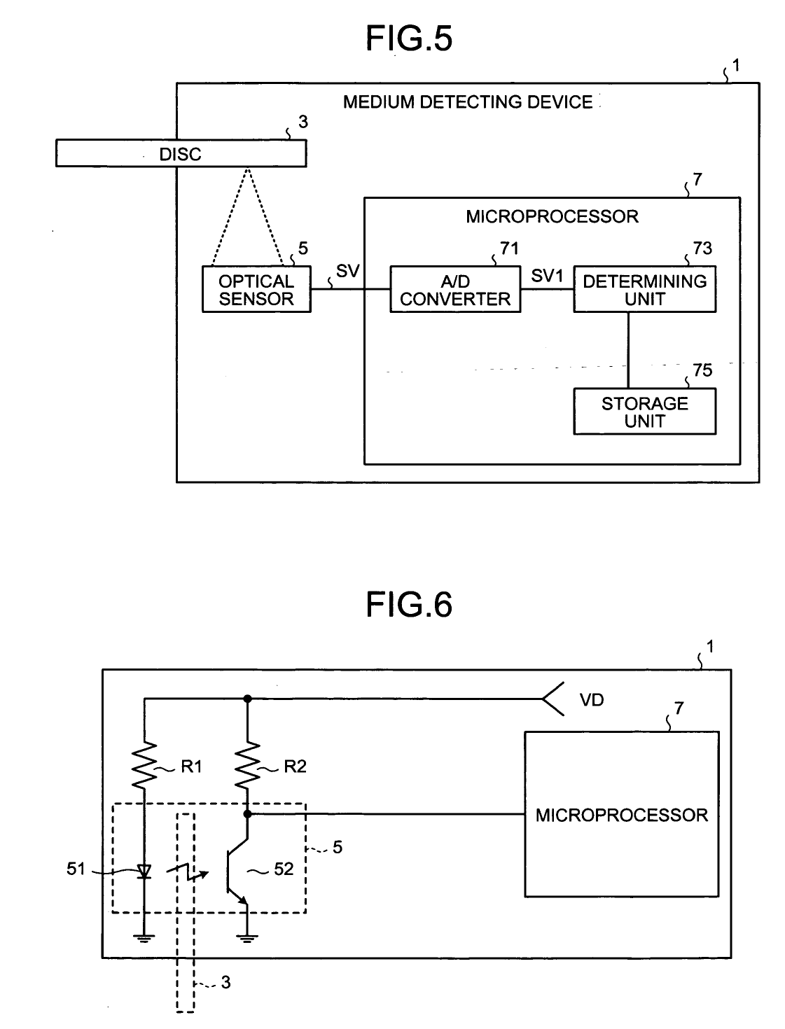

FIG. 5 is a block diagram of the medium detecting device 1. The medium detecting device 1 includes a microprocessor 7 and an optical sensor 5. The microprocessor 7 includes an analog/digital (A/D) converter 71, a determining unit 73, and a storage unit 75.

The optical sensor 5 is structured with, for example, an LED 51 (see FIG. 6) as a light emitting element, and a phototransistor 52 (see FIG. 6) as a light receiving element. The phototransistor is controlled to be on/off by light from the LED. The optical sensor 5 outputs a collector voltage of the phototransistor to the A/D converter 71 as an output SV of the optical sensor.

A principle of the optical sensor 5 is explained briefly with reference to FIG. 6. The phototransistor 52 is turned on when the phototransistor 52 receives the light from the LED 51, and a photocurrent flows. The photocurrent decreases the output SV. When the disc 3 is inserted in the medium detecting device 1, the disc 3 blocks the light from the LED 51. Thus, the phototransistor 52 is turned off, and the photocurrent stops flowing. As a result, the output SV increases, and in an ideal case, recovers to the value of the power source VDD.

A function of the determining unit 73 is realized by executing a computer program that is stored in a memory (not shown) for storing a computer program. With the function of the determining unit 73, the microprocessor 7 checks the output SV of the optical sensor 5, and judges whether the disc 3 is inserted in the medium detecting device 1.

The A/D converter 71 converts the output SV into a digital value, and outputs the digital value to the determining unit 73 as an output SV1. The storage unit 75 is, for example, a recordable memory, such as a random access memory (RAM), and stores a value of the output SV1 when the disk 3 is not inserted in the medium detecting device 1.

The determining unit 73 determines whether the disc 3 is inserted in the medium detecting device 1 based on the output SV1 and a predetermined variation α.

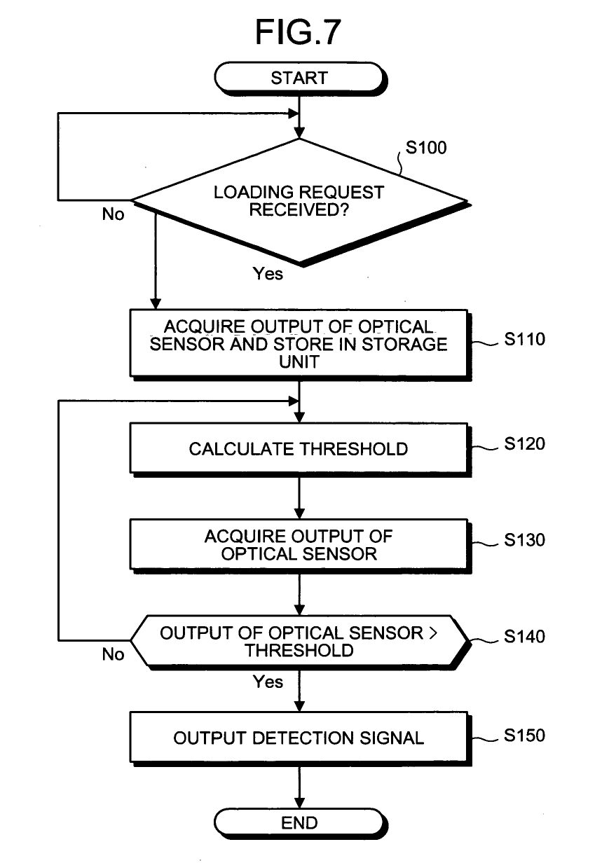

The process procedure performed by the medium detecting device 1 is explained with reference to a flowchart shown in FIG. 7. When the loading request for inserting the disc 3 is received from the playback processing unit 91, the determining unit 73 acquires (measures) a value of the output SV1 that is input by the A/D converter 71. The determining unit 73 stores the value of the output SV1 in the storage unit 75 as a reference value (steps S100 and S110).

The determining unit 73 reads the reference value from the storage unit 75, and calculates a threshold by adding a value of the variation α to the reference value (step S120). Then, the determining unit 73 acquires a value of the output SV1 for another time (step S130). The determining unit 73 compares the output SV1 just acquired with the threshold (step S140). When the value of the output SV1 is higher than the threshold, the determining unit 73 outputs a detection signal to notify that the disc 3 is inserted (step S150).

When the medium detecting device 1 detects the disc 3, the playback processing unit 91 loads the disc 3 and starts a playback processing.

The determining unit 73 repeats a series of processes that includes reading the reference value from the storage unit 75, calculating the threshold, and comparing a value of the output SV1 with the threshold, until the determining unit 73 acquires a value of the SV1 that is higher than the threshold (steps S120 to S140).

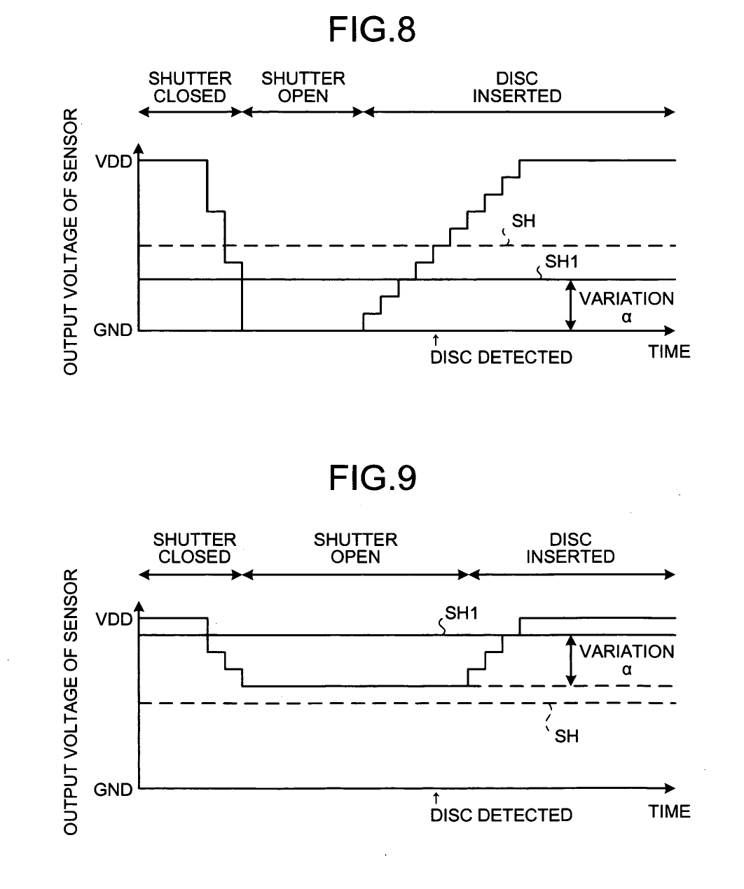

FIGS. 8 to 10 are graphs of the output SV1 of the optical sensor 5 when the photocurrent of the phototransistor has the typical value, the minimum value, and the maximum value respectively.. As explained above, the value of the photocurrent can be affected by various factors, such as the variation in the power source, parts, and temperature, time, and dirt on parts, to be the typical value, the minimum value, and the maximum value. The output SV1 shown in FIGS. 8 to 10 is of an open/close type apparatus in which the LED 51 and the phototransistor 52 are arranged on the same board, and a light guiding board that reflects the light from the LED 51 is arranged at a shutter. A structure of the optical sensor is not limited to a structure in which the LED and the phototransistor are mounted on an identical board, and may be a structure in which each of the LED and the phototransistor is arranged on an opposite side from each other with respect to an opening from which the disc is inserted without providing the light guiding board. The light guiding board is arranged in such a manner that the light guiding board receives the light from the LED 51 when the shutter is open, and the light guiding board does not receive the light when the shutter is close. In other words, when the shutter is open, the phototransistor 52 is turned on with the light from the LED 51 that is reflected by the light guiding board, and is turned off when the light is blocked by the disc 3 that is inserted between the board, on which the LED 51 and the phototransistor 52 are mounted, and the light guiding board.

FIG. 8 is the graph of the output SV1 when the photocurrent of the phototransistor 52 has the typical value. When the photocurrent has the typical value, the light from the LED 51 does not fall on the phototransistor 52 while the shutter is close. Without the light, the phototransistor 52 is not turned on and the photocurrent does not flow. Therefore, a value of the output SV1 is substantially equal to the power voltage VDD.

When the shutter opening action is started in accordance with the loading request for inserting the disc 3, the light from the LED falls on the phototransistor 52 through the light guiding board. Thus, the phototransistor 52 is turned on, and the photocurrent flows. As a result, the output SV1 started decreasing, and becomes 0 V when the shutter is completely open. The determining unit 73 performs acquisition of a value of the output SV1 when a time required for bringing the shutter to a state in which the shutter is completely open has passed since a reception of the loading request. The output SV1 thus acquired is set as the reference value. In other words, the reference value is the value of the output SV1 that is obtained when the shutter is completely open.

When insertion of the disc 3 is complete, the disc 3 blocks the light reflected by the light guiding board. Therefore, the phototransistor 52 is turned off, and the photocurrent stops flowing. As a result, the output SV1 increases, and in the ideal case, recovers to the value of the power source VDD. The determining unit 73 compares the output SV1 with a threshold SH1 that is calculated by adding the variation α to the reference value. When a value of the output SV1 is higher than the threshold SH1, the determining unit 73 determines that the disc 3 is present, and outputs the detection signal.

Thus, if the photocurrent of the phototransistor 52 has the typical value, when the disc 3 blocks the light to turn off the phototransistor 52, the output SV1 recovers to the value of the power voltage VDD. Therefore, it is possible to detect the disc 3 by comparing the output SV1 with the threshold SH, which is set at, for example, 50% of the power voltage VDD.

FIG. 9 is the graph of the output SV1 when the photocurrent of the phototransistor 52 has the minimum value. When the photocurrent has the minimum value, the light from the LED 51 does not fall on the phototransistor 52 while the shutter is close. Therefore, the photocurrent does not flow, and the value of the output SV1 is substantially same as the value of the power voltage VDD. When the shutter opening action is started in accordance with the loading request for inserting the disc 3, the light from the LED 51 falls on the phototransistor 52 through the light guiding board to turn on the phototransistor. Thus, the output SV1 decreases. The determining unit 73 performs acquisition of the output SV1 when the time required for bringing the shutter to a state in which the shutter is completely open has passed since a reception of the loading request. The output SV1 thus acquired is set as the reference value. In other words, the reference value is the value of the output SV1 that is obtained when the shutter is completely open.

When insertion of the disc 3 is completed, the disc 3 blocks the light reflected by the light guiding board is blocked by the disc 3. Therefore, the phototransistor 52 is turned off, and the photocurrent stops flowing. As a result, the output SV1 increases, and in the ideal case, recovers to the value of the power source VDD. The determining unit 73 compares the output SV1 with the threshold SH1 that is calculated by adding the variation α to the reference value. When a value of the output SV1 is higher than the threshold SH1, the determining unit 73 determines that the disc 3 is present, and outputs the detection signal.

However, if the photocurrent has the minimum value, the output SV1 does not decrease to the conventional threshold SH even when the shutter is completely open, being standby for a disc because the photocurrent is too low. If the output SV1 is compared with the threshold SH, it is determined, while the shutter is open, that the disc 3 is inserted even though the disc 3 is not inserted. On the other hand, the determining unit 73 acquires the output SV1 when the shutter is completely open as the reference value, and compares a value of the output SV1 with the threshold SH1 obtained by adding the variation α to the reference value. When the value of the output SV1 is higher than the threshold SH1, the determining unit 73 determines that the disc 3 is inserted. Therefore, it is possible to accurately detect insertion of the disc 3, even if the photocurrent has the minimum value.

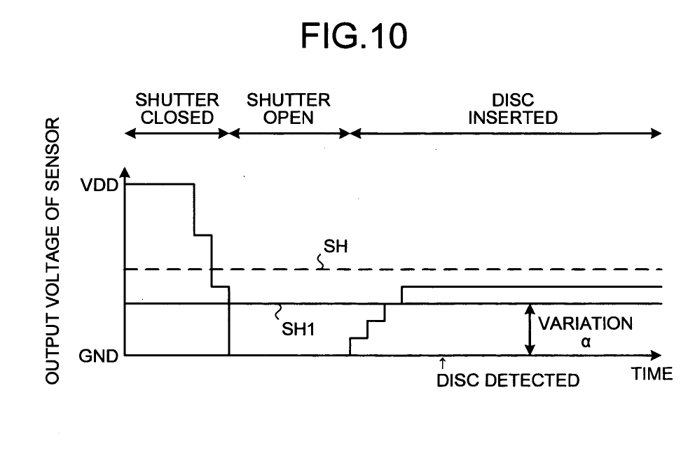

FIG. 10 is the graph of the output SV1 when the photocurrent of the phototransistor 52 has the maximum value. When the photocurrent has the maximum value, the light from the LED 51 does not fall on the phototransistor 52 while the shutter is close. Therefore, the phototransistor 52 is not turned on, and the photocurrent does not flow. The value of the output SV1 is substantially equal to the power voltage VDD.

When the shutter opening action is started in accordance with the loading request for inserting the disc 3, the light from the LED 51 falls on the phototransistor 52 through the light guiding board to turn on the phototransistor. Thus, the output SV1 decreases, and becomes 0 V when the shutter is completely open. The determining unit 73 performs acquisition of the output SV1 when the time required for bringing the shutter to the state in which the shutter is completely open has passed since a reception of the loading request. The output SV1 thus acquired is set as the reference value. In other words, the reference value is the value of the output SV1 that is obtained when the shutter is completely open.

When insertion of the disc 3 is completed, the disc 3 blocks the light reflected by the light guiding board. Therefore, the phototransistor 52 is turned off, and the photocurrent stops flowing. As a result, the output SV1 increases. The determining unit 73 compares the output SV1 with the threshold SH1 obtained by adding the variation α to the reference value. When a value of the output SV1 is higher than the threshold SH1, the determining unit 73 determines that the disc 3 is present, and outputs the detection signal.

However, if the photocurrent has the maximum value, because the photocurrent of the phototransistor 52 is too high, the output SV1 becomes stable at a value a little lower than the conventional threshold SH even though the disc 3 is present. Therefore, it is impossible to detect the disc 3 by comparing a value of the output SV1 with the threshold SH. On the other hand, the determining unit 73 acquires the output SV1 when the shutter is completely open as the reference value, and compares a value of the output SV1 with the threshold SH1 obtained by adding the variation α to the reference value. When the value of the output SV1 is higher than the threshold SH1, the determining unit 73 determines that the disc 3 is inserted. Therefore, it is possible to accurately detect insertion of the disc 3, even if the photocurrent has the maximum value.

If the disc 3 is the C-THRU disc, a value of the output SV1 becomes low even though the disc 3 is inserted, in a similar manner as a case of the photocurrent being at the maximum value. However, even the C-THRU disc is not 100% translucent and blocks light to some extent. Therefore, there is a difference between the value of the SV1 when the shutter is open and a value of the SV1 when the disc 3 is inserted. If a value of the variation α is set, at a design stage, considering translucency of the disc to be inserted, it is possible to detect even the C-THRU disc accurately.

As described above, in the present embodiment, the determining unit 73 acquires a value of the output SV1 in a state in which the disc is not inserted as the reference value, calculates the threshold by adding the predetermined variation α to the reference value, and compares a value of the output SV1 with the threshold. The determining unit 72 determines that the disc is inserted when the value of the output SV1 exceeds the threshold thus obtained, it is possible to accurately determine whether the disc is inserted without using the sorted parts. Therefore, the manufacturing cost can be decreased.

While in the present embodiment, a case in which the reference value is stored in the storage unit has been explained, the threshold that is calculated based on the reference value may be stored in the storage unit. If the threshold is stored, a process of calculating the threshold is only required once, thereby reducing the total number of processes.

Moreover, while in the present embodiment, a case in which the medium detecting device 1 is provided in the recording-medium playback apparatus 9 for the disc such as the DVD and the CD to determine the presence or absence of the disc has been explained, the medium for which presence or absence is to be determined is not limited to such disc.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A medium detecting device that detects a medium using an optical sensor and includes a determining unit that sets a reference value and determines whether the medium is present or absent from a difference between the reference value and an output value of the optical sensor, wherein
the reference value is an output value output by the optical sensor when the medium is absent.

2. The medium detecting device according to claim 1, wherein the determining unit determines whether the medium is present or absent by comparing the output value with a threshold that is calculated from the reference value and a predetermined variation.

3. The medium detecting device according to claim 2, wherein the threshold value is calculated by adding the variation to the reference value.

4. The medium detecting device according to claim 2, wherein the threshold value is calculated by subtracting the variation from the reference value.

5. The medium detecting device according to claim 2, wherein
the optical sensor includes a light emitting element and a light receiving element, and converts an output of the light receiving element into an output of the optical sensor,
the reference value is measured each time before detecting the medium, and
the variation is calculated based on translucency of the medium.

6. A recording-medium playback apparatus that loads and playbacks a recording medium when the recording medium is present, comprising:
a medium detecting device that detects the recording medium using an optical sensor and includes a determining unit that sets a reference value and determines whether the medium is present or absent based on a difference between the reference value and an output value of the optical sensor, wherein
the reference value is an output value output by the optical sensor when the medium is absent.

7. A medium detecting method for detecting a medium using an optical sensor, comprising:
measuring a first output value of the optical sensor, the first output value obtained when the medium is absent;
setting the first output value as a reference value;
measuring a second output value of the optical sensor; and
detecting the medium from a difference between the reference value and the second output value.

8. A computer-readable recording medium that stores therein a computer program that implements a method for detecting a medium using an optical sensor on a computer, the computer program causing the computer execute:
measuring a first output value of the optical sensor, the first output value obtained when the medium is absent;
setting the first output value as a reference value;
calculating a threshold based on the reference value and a predetermined variation;
measuring a second output value of the optical sensor;
comparing the second output value with the threshold; and
detecting the medium from a comparison result obtained at the comparing.
